(19) United States
(12) Patent Application Publication
(10) Pub. No.: US 2008/0118713 A1
(43) Pub. Date: May 22, 2008

(54) Polymer-Based Face Panel Veneer and Edgeband System for Producing Decorative Panels Having Increased Durability and Decorative Effect and Associated Methods for Producing Such a System

(76) Inventor: Robert Bordener, Bloomfield Hills, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/562,154

(22) Filed: Nov. 21, 2006

(51) Int. Cl. B32B 3/02; B32B 37/12; B32B 37/00; B32B 38/00; C09J 4/00

(52) U.S. Cl. 428/192; 156/60; 156/325; 156/326; 156/304.1; 156/244.11; 156/244.18

(57) ABSTRACT

The present invention discloses a polymeric resin-based veneer laminating system, associated article and method for producing, for maintaining a mating edge profile of top and edge applied laminates secured to a rigid substrate material, and without compromise to fit and finish in response to temperature and humidity variations existing between the materials. A first (typically PVA) adhesive is applied between the top laminate and associated top surface of the substratum according to a first application, a second adhesive (typically EVA) being applied to the adjoining side surface of the substratum and prior to application of the edgeband according to a further expedited heat and/or pressure application.

### BACKGROUND OF THE INVENTION

1. Field of the Invention

The present invention relates generally to decorative plastics materials and systems for various architectural structural component and accoutrement applications. More specifically, the present invention teaches a system for applying a flexible decorative shell material to a rigid substrate through the application of a substantially rigid adhesive in order to maintain fit and integrity in response to such as temperature and humidity variations. The present invention further discloses an associated method for fabricating plastic laminated articles with improved decorative attributes and increased durability.

2. Description of the Prior Art

In the plastics fabrication industry, the broad areas of plastics materials with decorative attributes can be roughly categorized into three main categories: 1) solid thick panels of substantial weight and cost—e.g. the solid surface industry and the natural stone industry; 2) the fiberglass reinforced panel industry—e.g. FRP, and 3) the laminate fabrication industry—e.g. Wilsonart, Formica and various similar materials employed in applications such as plastic utility panels. It is the latter that is the substantial concern of this invention, being both the largest industry and the one with the fewest improvements in fabrication techniques and improved systems therefor.

Solid surface panels have been in existence since their invention and introduction by Du Pont in the 1960s, as pioneered by Dr. Donald Slocum. Examples of such materials are those commercially available under the trade name Corian®. Such materials are typically fabricated by means of gluing together ½ inch solid panels to create monolith structures to be used for windowsills, countertops, etc. They are colored most commonly via a smashed ingot system wherein the ingot granules are suspended in relatively clear resin. This process is well documented and need not be repeated here.

Examples of materials with an excellent stone-like appearance are relatively abundant when using thermoset materials of the relevant art and as described above; solid surface materials such as the Corian® materials as well as various materials such as those disclosed in various references such as U.S. Pat. No. 3,562,379 to Duggins or U.S. Pat. No. 4,085,246 to Buser; U.S. Pat. No. 4,544,584 to Ross; U.S. Pat. No. 5,476,895 to Ghahary; and U.S. Pat. Nos. 5,628,949; 5,885,503 and 6,517,897 to Bordener, etc.

U.S. Pat. No. 5,476,895 to Ghahary discloses sprayable granite-like coating compositions for use in the FRP industry. The coating may be sprayed onto an existing prefabricated particleboard structure, and to large measure provide the granite-like appearance of the outer layer. Moreover this fabrication process does a good job of providing a waterproof structure and provides a minimum of visible seams.

Additional relevant examples selected from the prior art for securing a first material (e.g. such as a polymer) to a second substratum material (further such as a cellulose) include such as the method for adhering materials having different expansion properties and associated articles formed therefrom, as set forth in U.S. Pat. No. 5,624,737, issued to Fairbanks et al. Fairbanks teaches in one example such as a thermoplastic coating material applied onto a cellulose based substrate. A composite adhesive includes both a rigid adhesive such as an epoxy or acrylic and a laminating adhesive such as a rubber based contact cement. In a preferred embodiment, a spline material is rigidly adhered to the coating material so as to reinforce the bond between the substrate and coating, and in particular where two pieces of coating material are attached at a seam. In a further preferred embodiment, the composite adhesive and/or spline material is used in preparing composite articles such as counters, sinks, furniture, profile edging, chemical resistant lab tops, showers and the like.

Similarly, U.S. Pat. No. 6,074,727, issued to Miller et al., teaches substantially the same arrangement as described above, with the further teaching of an embodiment whereby several individual articles of manufacture can be adhered together so as to create a seamless appearance therebetween.

Powell, U.S. Pat. No. 4,618,390, teaches a flexible substrate (e.g. a vinyl, cloth, paper, etc.) to a rigid wood substrate. The method comprises consolidating the two substrates through the medium of a curable adhesive composition consisting essentially of an aqueous emulsion of a butyl acrylate-methyl methacrylate-2-hydroxyethyl acrylate terpolymer adjusted to pH 9 to pH 10 with 2-amino-2-methyl-propanol, polypropylene glycol, an acrylamide-acrylic acid copolymer thickener, containing a dispersed poly-isocyanate hardening agent. Decorative vinyl/wood laminates for use in mobile home construction can be advantageously prepared in this manner.

U.S. Pat. No. 4,005,239, issued to Davis et al., teaches a decorative laminated panel and a process for making including coating the backmost flat surface of a laminate with a uniform layer of a solution of an elastomeric adhesive and removing excess solvent, coating one face of a compressible, flexible, closed cell polypropylene plastic foam sheet with a solution of an elastomeric adhesive and removing solvent, superimposing the decorative laminate over the polypropylene sheet with the adhesively coated side of the polypropylene foam, and applying pressure to the flat surface of the laminate and plastic foam so as to form a unitary panel. To bond the decorative laminated panel to a substrate, one can apply an elastomeric adhesive to the back of the panel and to a rigid substrate and install the panel by pressing against the rigid substrate to which the panel is attached.

Thermoset materials have drawbacks as well. These include issues such as material brittleness that can impair material performance life and the like. Thermoset materials can also have relatively high material costs as well as require high processing costs to provide the desired product. Additionally, the thermosetting nature of the polymeric material severely limits thermoforming options. Finally thermoset materials of the nature contemplated and discussed are difficult to successfully form into an extremely thin veneer. Such thin veneer can be desirable in various applications.

Typically, in the decorative plastics industry, sheet material is often defined as having thicknesses greater than approximately 0.1 inch. With solid surface materials, available sheet thicknesses are at least ¼ inch and most typically ½ inch in order to provide sufficient strength and impact resistance for material handling and shipping. However, there is a growing desire to provide materials having thicknesses as low as 0.05 inches or less, as is typical of veneers in other building material markets. Such materials would provide significant advantages regarding reductions in overall material cost, shipping cost, weight reduction, thermoformability, and the like.

Early attempts to make thin veneers featuring a good stone-like appearance utilized two basic methodologies. The first was U.S. Pat. No 5,628,949 to Bordener, originally commercialized under the trade name Korstone®. This is a spray-process solid surface which created a two-layer solid surface composite that is able to be molded into various shapes, etc. Drawbacks of this system include au article of significant cost and bulk that is difficult to transport. The second was a product marketed under the trade name SSV™ by the Ralph C. Wilson Co. of Temple, Tex. The process involved manufacturing a solid surface sheet as generally described therein and extruding it into a thinner sheet of approximately 0.090 inch. The material produced by this process exhibited high percent breakage on production (thermoset materials are typically too brittle to be cast so thin) and very poor physical performance upon installation over a rigid substrates such as countertop applications. While the process disclosed in Bordener '949 was successful both physically and in the market, it did not address the broadest channel of the market—the pre-cast sheet. Bordener '949 (and other related patents by the same inventor) are best utilized to make pre-cast shaped articles, where the largest market segment in solid surface material is pre-cast sheet stock.

Polyvinyl acetate (PVA) glue is well-documented as an invention of the 1950s and commonly known as Elmer's Glue-All. This is exemplary of a broadly incorporated family of substantially rigidly bonding water-based aliphatic adhesives used to bond wood and plastics in a variety of circumstances. Ethylene vinyl acetate (EVA) represents a well documented adhesive family commonly used in industrial environments. It has demonstrated ability to bond wood and plastics and can be reacted with heat and within a very short time. All the “EVA-style” adhesives referenced hereinbelow include heat-reacted adhesive systems commonly referred to as “hot melt” adhesives.

PVA-type adhesives have many industrial uses and are commonly used to bond laminate to wood substrate. Contact adhesives are used in the same application, sometimes to ease the inevitable movement between laminate and substrate. These prior art laminate panels, typified by those sold under the trade name “Formica” are thermoset in composition and are extremely rigid. The panels they are bonded to are wood and move greatly with changes in temperature and humidity. This relative movement between laminate and substrate causes many problems to the industry and the end user alike. If the contact cement-type adhesive is used, then the laminate panel moves greatly relative to the wood substrate and shrinks away from the edge in certain environmental conditions causing the wood substrate to be exposed to water, moisture, dirt, dust, sunlight, and degrading both the substrate and the bond to the laminate.

In the case a substantially rigid PVA-style glue is used, then the laminate still moves in the same manner as in the before example, but less so, causing smaller levels of the same problems as before. Additionally, the laminate is now more subject to stress cracking than if a more flexible adhesive was employed. In general, laminate structures enjoy substantially reduced durability and longevity due to this relative movement between itself and the wood substrate it is bonded to. This creates edge chips when the laminate “overbites” the substrate, and substrate and glue bond damage due to excessive joint size when there is “underbite” along the joint area. All this is not to even mention the degraded aesthetics involving all the aforementioned examples.

Ethylene vinyl acetate (EVA)-based adhesive materials have been in existence for some time. They are commonly used only in very specific applications in the laminate industry. Specifically, laminate is too stiff and too brittle to be bent quickly or around very tight radii. It also is subject to impact damage, even from mild use applications, making it poorly suited for edgework, even for such in laminate structures. To say it plainly, laminate is such a poor material it is often not used to trim the edges of laminate-clad articles. Presently the preferred edge trim for laminate articles is thermoplastic edgeband, such as sold by a variety of manufacturers, including Doellken®, of Germany. This edgebanding, as all others on the market, has a substantially solid color thereon, or the appearance of a faux wood—some rather convincingly. This thermoplastic edgebanding material is often applied via EVA-type adhesives for expediency as the system provides an extremely tough bond in a very short amount of time. Traditional laminate materials cannot be conveniently bonded with EVA-type adhesives as they are too stiff and too brittle both for the machinery and for the final application (face edging of countertops, decorative panels).

While the focus of the entire industry has been to solve these problems with developments in adhesives, it will be shown, rather incredibly, that these problems are better solved with an innovative laminate material itself and, further, with the additional incorporation of a novel adhesive system.

What is lacking in the prior art is the provision of a laminate material exhibiting flexibility, and in particular expandability to permit contraction with relative changes in the wood substrate that laminate is bonded to. This will provide the possibility of a non-moving joint, particularly when a relatively more rigid adhesive is used with a relatively less rigid (more flexible) laminate material.

There further exists a long-felt need for plastic laminate materials and articles therefrom having satisfactory aesthetic appearances post fabrication, especially those with a visual stone-like or other desirable appearance. This has been difficult to achieve in an efficient and economical manner particularly in situations where a thin veneer is utilized. Thus, it is highly desirable to provide a plastic fabrication system that provides for tight non-moving joints with high integrity, rapid fabrication, and improved durability at the joints between panels and especially on any outside corners or edges.

The prior art further fails to provide an improved laminate-based article which allows substantially identical appearance in materials in both the top decking and the edgebanding, while also providing improved durability, and to extend the useful lifecycle of such structures and accoutrements. Thus it would be desirable to provide a veneer laminating system providing improved durability and superior decorative effect than that disclosed in the prior art.

### SUMMARY OF THE INVENTION

The present invention addresses the shortcomings outlined in the various relevant art references and is broadly directed to a plastic material composed at least in part of a thermoplastic polymeric resin material and a coloration system. The coloration system is one that is compatible with plastic resins and known low cost extrusion processes and, preferably one that can also be used in thermoset resin systems, and especially in a combination of the two.

In additional and relevant part, the present invention teaches a system and associated method for assembling both top veneer and edgeband materials, such as including at least one thermoplastic based component (without limitation) and flexible laminate sheets, onto a rigid substrate, this through the further provision of a substantially rigid adhesive interposed between the sheet and underlying substratum, this in order to maintain appropriate fit and integrity in response to such as temperature and humidity variations. The instant invention is also directed to a system of two adhesive processes, particularly when used in a specific sequence relative to one another, to create an article with both large surface areas and narrower edge areas. Also included in the present method is the ability to prepare a polymeric article such as, but not limited to, a polymeric laminate clad panel having specific specifications of thickness relative to the laminate.

According to additional detailed variants, the invention is further practiced by bonding a sheet of the at least partially thermoplastic based laminate to a planar face or other surface of a substrate, preferably a sheet of particleboard, such as with a PVA-type adhesive which is substantially less flexible (i.e. more rigid) than the laminate sheet. The associated edgebanding feature further includes at least one additional thermoplastic component, in one variant most preferably exhibiting a visually differentiable decorative component therein. The edgeband may further be applied via an EVA-type adhesive process, such further exhibiting heat above 112° F., and such that the EVA-based adhesive is cured to at least 25-50% of its bonding strength in less than 60 seconds from application.

In one preferred variant, geometric considerations for best practicing the invention include a relatively flexible laminate surfacing, preferably less than 0.2 inch and greater than 0.012 inch in thickness, the substrate material preferably being greater than 0.35 inch in thickness, and the corresponding edgebanding material in a desired embodiment being greater than 0.5 mm and less than 10 mm.

In one non-limiting application, the top laminate material will incorporate a decorative component intermixed therein, especially if the decorative component includes at least one type of visually differentiable granule. Such may further contemplate the printing of a two dimensional image of ink dots to simulate a three dimensional appearance, in one instance of granite. Correspondingly, the edgeband material may exhibit a matching decorative component, and may also include by preference a visually differentiable granule. It is also desirable to have a translucent component to both the edgeband and top laminate material, with a bond between the two.

Additionally, polymer materials employed in the top (planar surface) laminate may be 100% thermoplastic, but are best to be a combination of thermoset and thermoplastic resin—the preferred embodiment having a translucent component and visually differentiable granules therein, and have at least two strata layers thereto. The edgeband material is best made from at least 10% thermoplastic resin, and is preferred to include at least 10% PVC resin in at least one strata layer. The edgeband is also most preferred to include at least two strata layers and to be between 1 and 5.5 mm thick.

Additionally, preferred granule materials include those from the RJ Marshall Co. of Southfield, Mich.; Safas Corp. of Clifton, N.J.; multiple product lines from ACS of Phoenix, Ariz,; and more preferably those formally available from All Plastics of Waterford, Mich., especially those made from colored mica, cellophane, biopolymer, and ground/shredded plastic film. Metal flakes and other commercially available pigment materials may also be used.

### DESCRIPTION OF THE DRAWING FIGURES

Reference will now be made to the attached drawings, when read in combination with the following detailed description, wherein like reference numerals refer to like parts throughout the several views, and in which:

FIG. 1 is a perspective illustration of an edgeband system installed onto a substratum material and according to a preferred embodiment of the present invention;

FIG. 2 is an exploded view of the edgeband system according to FIG. 1;

FIG. 3A is a first side plan view of a Prior Art edgeband system in a first misalignment condition;

FIG. 3B is a second side plan view of another Prior Art edgeband system in a second misalignment condition;

FIG. 4 is a side plan view of an edgeband system according to the present invention and illustrating the ability to expand or contract without compromising an associated fit and finish established between the top and edge extending laminates; and

FIG. 5 is an enlarged illustration of a mating edge profile established between the top and edge extending laminates according to possible design variations.

### DETAILED DESCRIPTION OF THE PREFERRED EMBODIMENTS

As described previously, the present invention discloses a polymeric resin-based veneer laminating system, associated article and method for producing, which is an improvement over prior art assemblies in that it enables the provision of a mating edge profile of top and edge applied laminates (defined as any material exhibiting at least in part a thermoplastic component) secured to a rigid (i.e. usually particleboard) cellulose or other material, and without compromise to fit and finish in response to temperature and humidity variations existing between the materials. These objectives, as will be further described, are facilitated such as by the use of a first (typically PVA) relatively rigid (relative to the laminate material, e.g. the laminate will yield prior to adhesive completely yielding or bond failure) adhesive applied between the top laminate and associated top surface of the substratum, as well as the application of a second adhesive (typically EVA) in a heat/pressure application, this setting much more quickly than the PVA adhesive, however providing similar dynamic characteristics.

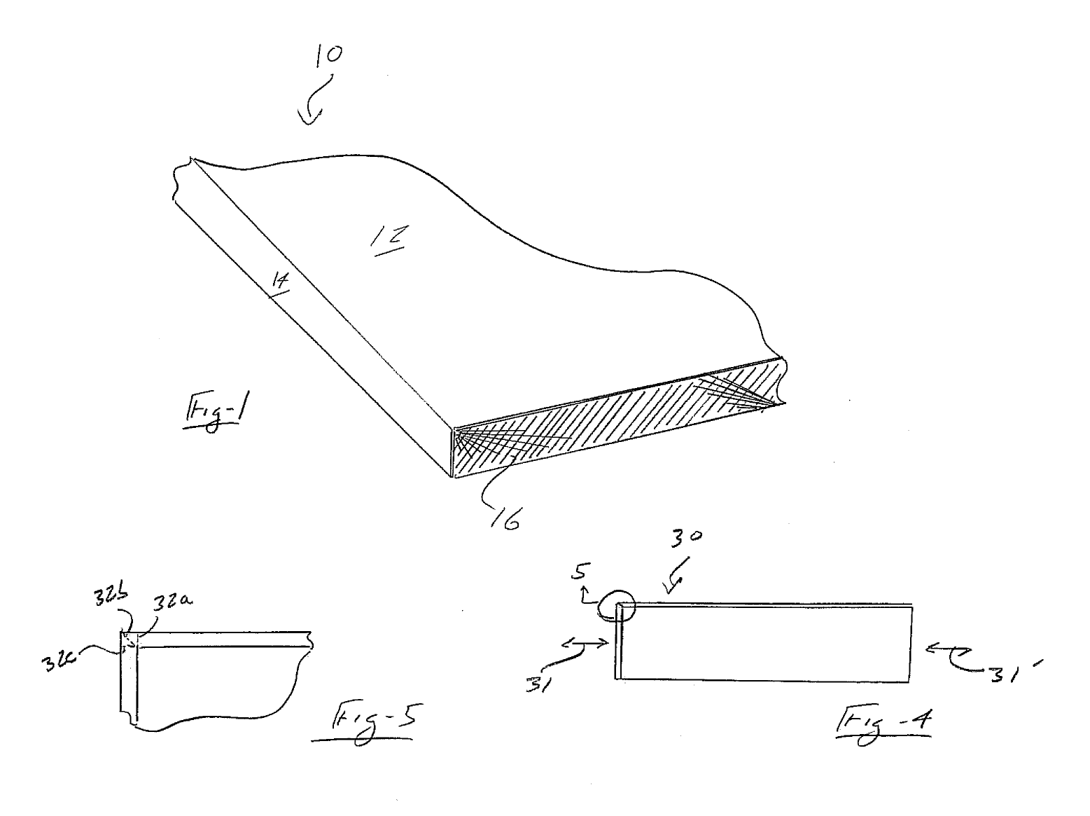

Referring to FIG. 1, a perspective illustration is shown at 10 of an edgeband system according to the present invention installed onto a substratum material. In particular, a first top laminate sheet 12 and a second edgeband strip 14 are secured to associated surfaces of a substrate material 16, such as in particular a rigid particleboard or other suitable cellulosic based material.

As better described in the exploded view of the edgeband system according to FIG. 2, the top sheet 12 and associated edge strip 14 of material are provided according to any known construction (such as including Formica® style laminates as is commercially known in the art) incorporating at least a thermoplastic component. As previously described, additional thermoset, granular (decorative) based or other material ingredients can also be provided in either or both the top 12 and side 14 materials. In use with more rigid contact adhesives, as will be subsequently described and in substitution of prior art and flexible adhesives, the net overall resistance of the structure offer less resistance (and more aptitude) to shrink or expansion, resulting from the dynamic performance characteristics of the laminate and underlying adhesives working in tandem and relative to the dynamic performance characteristics of the substratum material 16.

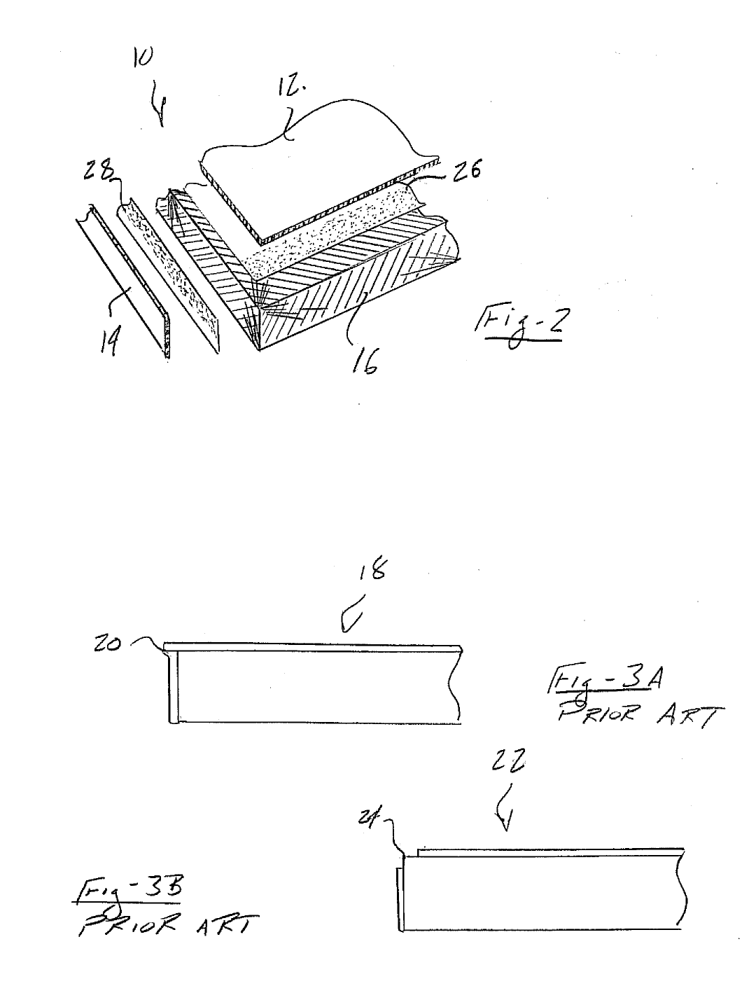

Referencing FIG. 3A, a first side plan view is shown at 18 of a Prior Art edgeband system in a first misalignment condition, and by which such as temperature and humidity conditions can cause either or both the top and edge laminates to expand, causing either or both a misalignment and fracture condition, see at 20, along the associated side edge profile. As further shown in FIG. 3B, a second side plan view 22 of another Prior Art edgeband system is illustrated according to a second misalignment condition 24, and by which either or both the top and side edges pull away from each other to reveal an exposed edge associated with the more rigid substratum. The root cause of the misalignment conditions noted in the Prior Art illustrations of FIGS. 1 and 2 lies in the inherent weaknesses of the underlying glues, which in combination with the substantially rigid laminates of the prior art, and the system is unable to “flex” in response to environmental conditions, the net result of which is that the expansion and contraction forces are transferred to the surface laminates, which are unable to expand, contract in concert with the substrate and/or fracture as a result of their inherent brittleness.

The present invention seeks to create a further improved complete system by preventing the occurrence of misalignment conditions resulting from the disparity between the more flexible laminate and the less flexible, more rigid, substratum material. This is accomplished through the provision of at least one and (in one preferred application) a pair of PVA and EVA adhesive materials interposed between the top and side edge decorative laminates and the underlying substratum.

As previously described, a first substantially rigid polyvinyl acetate-based (PVA), contact cement, aqueous adhesives, EVA-based adhesive materials, see as referenced at 26 in FIG. 2, is provided and which provides a rigidity factor rated between that of an at least less rigid laminate and a commensurately rigid or potentially more rigid substratum. In cooperation, a second ethylene vinyl acetate (EVA) adhesive 28 is provided between the edgeband 14 and the associated front edge face of the substratum (e.g. particleboard) 16. The adhesives may also include compositions known in the art and selected from such as Helmetin®, 3M® (e.g. high strength-90) and Mitsui® adhesives.

According to one desired application, the PVA adhesive 26 is applied as a coating in a general application, over which the decorative top laminate 12 is applied and allowed to set. Concurrently, the EVA adhesive 28 is applied according to a process, such further exhibiting heating above 112° F. and/or applying an elevated pressure component for a period of time, such as approximately 1 hour, and such that the EVA-based adhesive is cured to at least 50% of its bonding strength in less than 60 seconds from application. In this manner, the more rapid set time associated with the EVA adhesive applied coating 28 will result in a further decreased tendency of the associated edgeband laminate 14 to “pull away” or otherwise establish a misalignment condition relative to the top PVA adhesive supported laminate 12.

This is due at least in part to the planar shaped materials being relatively more flexible than their respective (PVA and EVA) adhesives. This differential is further explainable in terms of the relative values in flexular modulus (e.g. modulus of elasticity) as well as glue sheer forces. These values are particularly susceptible to variances in humidity and temperature. It is also envisioned that either or both of the adhesives be incorporated (or preapplied) into a rearmost stratum layer of the laminate(s). Alternatively, an EVA-based primer may be affixed to the (laminate) sheet backside, and a pressure component applied for a period of time less than 24 hours.

Referencing FIG. 4, a side plan view of an edgeband system according to the present invention, see at 30, illustrates the ability to expand or contract about the directions indicated by arrow 31 and 31′, without comprising to an associated fit and finish established between the top and edge extending laminates, this further in contrast to the misalignment conditions associated with the prior art adhesive application processes of FIGS. 3A and 3B. Referencing finally, FIG. 5, an enlarged illustration of a mating edge profile established between the top and edge extending laminates is illustrated according to possible design variations and which correspond to vertical 32a, angled 32b or horizontal 32c seam profiles. While not further illustrated, it is clearly understood that the system, article and method according to the present invention is also contemplated to employ rounded, modified angled and other suitable edge profiles and whereby it is desired to maintain an appropriate seam or edge between the top and edgeband laminates.

As previously described, and according to one preferred variant, geometric considerations for best practicing the invention include a relatively flexible laminate surfacing, preferably less than 0.2 inch and greater than 0.012 inch in thickness, the substrate material preferably being greater than 0.35 inch in thickness, and the corresponding edgebanding material in a desired embodiment being greater than 0.5 mm and less than 10 mm.

In one non-limiting application, the top laminate material will incorporate a decorative component intermixed therein, especially if the decorative component includes at least one type of visually differentiable granule. Correspondingly, the edgeband material may exhibit a matching decorative component, and may also include by preference a visually differentiable granule. It is also desirable to have a translucent component to both the edgeband and top laminate material, with a bond between the two, thereby allowing at least some visible light transmission across the joint or seam.

Additionally, polymer materials employed in the top (planar surface) laminate may be 100% thermoplastic, but are best to be a combination of thermoset and thermoplastic resin—the preferred embodiment having a translucent component, and visually differentiable granules therein, and have at least two strata layers thereto. The edgeband material is best made from at least 10% thermoplastic resin, and is preferred to include at least 10% PVC resin in at least one strata layer. The edgeband is also most preferred to include at least two strata layers and to be between 1 and 5.5 mm thick.

Additionally, preferred granule materials include those from the RJ Marshall Co. of Southfield, Mich.; Safas Corp. of Clifton, N.J.; multiple product lines from ACS of Phoenix, Ariz,; and more preferably those formally available from All Plastics of Waterford, Mich., especially those made from colored mica, cellophane, biopolymer, and ground/shredded plastic film. Metal flakes and other commercially available pigment materials may also be used.

An associated method according to the present invention includes at least the steps of a method for creating a three-dimensional article with top and edge surfaces exhibiting a mating edge, comprising the steps of providing a relatively rigid substrate material including at least a first surface and a second non-planar surface defining therebetween an extending edge; applying a first substantially rigid adhesive applied to the first surface and a second likewise substantially rigid adhesive to the second surface, and overlaying a first substantially planar shaped material exhibiting a specified thickness upon the first adhesive and a second edgeband material upon the second adhesive, such that a first selected edge of said first material is arrayed in opposing and abutting fashion with a further selected edge of the second material, along the extending substratum edge. In this fashion, the adhesives respond dynamically to environmental variances including at least temperature and humidity to prevent misalignment of the planar shaped materials, at least along the mating edge, and relative to the associated substratum.

Additional variants include both apparatus, method of producing and associated business models for producing plastic resin edgeband materials, these having been a staple in the laminate business for several decades due to their improved physical performance over laminate strips in similar use application. Surprisingly, few innovations have been made in the application or utilization of this important material, and which is manufactured and made available for sale on every continent of the globe.

Presently available variants of edgeband material include the majority used monochromatic PVC resin extruded variety. This material outperforms laminate ribbon in impact, chip resistance and overall scuff resistance since it is color-through. The material is usually sold in black or increasingly often in a color-matched variety so as to at least look somewhat like the laminate it is applied to, thus providing at best a very basic appearance at best.

Attempts at metallic-appearing edgeband surfaces have included a metal veneer surface bonded to a standard laminate backing, this with results no better than that achieved with other laminates. The term “laminate” as used herein is also intended to designate commercially available products, as is commonly available under the tradenames Formica®, Pionite®, Wilsonart® and the like.

An improvement in this technology contemplated encompasses making an edgeband from a thin layer of metal associated with a base surface, and then covering the same with a thicker protective layer of clear plastic. Such a material exhibits better performance, dependent upon the type of metal used, since their glue performance would vary with the actual metal used. Additionally, an edgeband produced in this fashion may also exhibit bends, kinks and dents, such as like a real metal, also limiting its performance. The clear coating also tends to give the impression that the metal is behind glass and that it is not a metal surface.

Other edgeband technologies include faux-printed wood grains by printing streams of colors along the band as it runs along a print head. Other appearances further include the inclusion of tiny specs of differing color in one rearward layer and a coordinating color effect in an upper layer to give the impression of a thick appearance. None of these materials, other than the wood grain, match up with the appearance of the surface material used in the non-edge portion of the panel being laminated to create a “fall thickness” appearance of the laminate panel.

The present invention accordingly teaches an improved metal-appearing edgeband that is indistinguishable from real metal, yet does not kink or dent, costs significantly less than previously known and available applications, and glues with the standard industry glue chemistry. The metallic appearing edgeband may also exhibit consistent, color-through characteristics, and such that it can be routed and shaped just like plastic without sacrificing its appearance.

Also taught is a business model for making a printed thin, low cost, edgeband that coordinates to a three dimensional plastic resin laminate, such as to provide faux impression that the entirety of the laminated article is a “full thickness” material. The present invention further contemplates an improved business model for making such an edgeband as an actual 3D product, thereby matching the color of the top laminate very closely with a light-penetrate-table and mating joint, thereby establishing a near perfect representation that the laminated article is a full-thickness product. The edgeband materials are further contemplated as being extruded in sheet form from such as an olefin, ABS and acrylic material, such filter being sectioned in ribbon form (e.g. in ½″ to 1⅝″ widths) and applied as an edgeband to standard Formica® countertops.

Having described my invention, other and additional preferred embodiments will become apparent to those skilled in the art to which it pertains, and without deviating from the scope of the appended claims.

I claim:

1. A system for creating a three-dimensional article with top and edge surfaces exhibiting a mating edge, comprising:
a substrate material including at least a first surface and a second non-planar surface defining therebetween an extending edge;
a first adhesive applied to said first surface and a second adhesive applied to said second surface; and
a first substantially planar shaped material exhibiting a specified thickness and overlaying said first surface sandwiching said first adhesive therebetween, a second material overlaying said second surface, likewise sandwiching said second adhesive therebetween, and such that a first selected edge of said first material is arrayed in opposing and abutting fashion with a further selected edge of said second material, along said extending substratum edge, said first and second planar shaped materials being relatively more flexible than said associated adhesives;
said adhesives each exhibiting a rigidity greater than that of an associated substrate material and responding to environmental variances including at least temperature and humidity to prevent misalignment of said planar shaped materials, at least along said mating edge, and relative to said associated substratum.

2. The system as described in claim 1, said first adhesive further comprising at least a vinyl acetate-component.

3. The system as described in claim 2, further comprising an aqueous component incorporated into said first adhesive.

4. The system as described in claim 2, said second adhesive further comprising at least an ethylene vinyl acetate.

5. The system as described in claim 4, further comprising said EVA adhesive being applied as a hot melt adhesive at an elevated temperature and with a specified pressure.

6. The system as described in claim 5, further comprising said EVA adhesive application curing to at least 50% of a maximum bonding strength within sixty seconds from application.

7. The system as described in claim 1, each of said first and second planar shaped materials each having a specified shape and size and further comprising at least a thermoplastic component.

8. The system as described in claim 7, said planar shaped materials each further comprising at least one of a thermoset component and a decorative additive including one of decorative granules and fluid additives.

9. The system as described in claim 1, said first planar shaped material having a specified shape and size and further comprising a thickness in a range of between 0.012 inch to 0.20 inch.

10. The system as described in claim 1, said second planar shaped material having a specified shape and size and further comprising a thickness of between 0.5 mm to 10 mm.

11. The system as described in claim 8, at least one of said first and second planar shaped materials having a specified shape and size and further comprising a combination of thermoplastic and thermoset resins exhibiting visually differentiable granules therein.

12. The system as described in claim 11, further comprising a translucent component established between said first and second planar shaped materials.

13. The system as described in claim 7, said second planar shaped material further comprising at least a 10% thermoplastic resin, at least a further 10% PVC resin within at least one of two strata layers each between 1 and 5.5 mm in thickness.

14. A decorative laminate article, comprising:
a substrate material including at least a first surface and a second non-planar surface defining therebetween an extending edge;
a first planar shaped material exhibiting a specified thickness and overlaying said first surface, a second edgeband material overlaying said second surface, such that a first selected edge of said first material is arrayed in opposing and abutting fashion with a further selected edge of said second material, along said extending substratum edge;
said laminate article resisting environmental variances including at least temperature and humidity to prevent misalignment of said planar shaped top and edgeband materials, at least along said mating edge, and relative to said associated substratum.

15. The article as described in claim 14, further comprising a first adhesive pre-applied to said first substratum surface and a second likewise adhesive pre-applied to said second substratum surface and prior to application of said first planar shaped and second edgeband materials.

16. The article as described in claim 15, said first adhesive further comprising an aqueous based adhesive, said second adhesive farther comprising an EVA adhesive applied in a fast setting and hot melt fashion.

17. The article as described in claim 14, each of said planar shaped and edgeband materials having a specified shape and size and farther comprising at least one of a first thermoplastic and a second thermoset resin.

18. The article as described in claim 17, said planar shaped materials each further comprising at least one visually differentiable decorative additive selected from decorative granules and fluid additives.

19. The system as described in claim 14, further comprising a translucent component established between said first and second materials.

20. A method for creating a three-dimensional article with top and edge surfaces exhibiting a mating edge, comprising the steps of:
providing a substratum material including at least a first surface and a second non-planar surface defining therebetween an extending edge;
applying a first adhesive applied to said first surface and a second adhesive to said second surface; and
overlaying a first substantially planar shaped material exhibiting a specified thickness upon said first adhesive and a second edgeband material upon said second adhesive, such that a first selected edge of said first material is arrayed in opposing and abutting fashion with a further selected edge of said second material, along said extending substratum edge;
said adhesives each exhibiting a rigidity greater than that of an associated substrate material and responding dynamically to environmental variances including at least temperature and humidity to prevent misalignment of said planar shaped materials, at least along said mating edge, and relative to said associated substratum.

21. The method as described in claim 20, further comprising providing at least one of a cellulose and a polymer based substratum exhibiting a rigidity greater than said planar shaped and edge based materials.

22. The method as described in claim 20, further comprising the step of providing at least one of said first and second adhesives from the group including Helmetin®, 3M® (high strength-90) and Mitsui® chemicals.

23. The method as described in claim 20, further comprising the step of applying said second adhesive as a hot melt adhesive at an elevated temperature and with a specified pressure.

24. The method as described in claim 22, further comprising the step of curing said second adhesive to a range of at least 30% to 50% of a maximum bonding strength within sixty seconds from application.

25. The method as described in claim 21 further comprising the step of providing said first adhesive as having an aqueous based component.

26. The method as described in claim 21, further comprising the step of incorporating an aqueous based and spreadable liquid into at least one of said first and second adhesives.

27. The method as described in claim 21, further comprising the step of providing said second adhesive as an ethylene vinyl acetate.

28. The method as described in claim 21, further comprising the step of forming at least one of said first planar shaped and second edgeband shaped materials as with at least a thermoplastic component.

29. The method as described in claim 28, further comprising the step of combining thermoplastic and thermoset resins in each of said first and second materials, each further exhibiting visually differentiable granules interspersed therein.

30. The method as described in claim 29, further comprising the step of applying a translucent component established between said first and second materials.

31. An edgeband laminated article in use with a corresponding top surface laminate positioned along a mating edge, said edgeband article, comprising:
a base layer of a plasticized material incorporating a decorative component and corresponding to a base surface, and
a top layer of a clear protective plastic applied over said first layer and in order to create a faux appearance of an entirety of a thickness of said laminated article being consistent with said first layer

32. The edgeband laminated article as described in claim 31, farther comprising said co-laminated article exhibiting a consistent, color-throughout characteristic which is adaptable to routing and shaping without sacrifice to its appearance.

33. The edgeband laminated article as described in claim 31, said base layer further comprising a metal component.

34. A business model for producing a printed edgeband material, comprising:
providing a first layer including a decorative material and a second clear protective layer of a plasticized material which is co-laminated over said first layer in order to create a faux appearance that an entirety of the laminated article is constituted by said first layer decorative material; and
matching a selected edgeband laminate by color with an existing top laminate along a light-penetrate-table and mating joint established between said edgeband and existing top laminate, thereby establishing a representation that the edgeband laminated article is a full-thickness product.

35. The business model as described in claim 34, further comprising extruding at least one of said first and second layers of said edgeband material in sheet form using at least one of an olefin, ABS or acrylic material.

36. The business model as described in claim 35, further comprising sectioning a coextruded and co-laminated article into ribbons, each exhibiting a width in a range of between ½″ to 1⅝″.
